(19) United States
(12) Patent Application Publication
(10) Pub. No.: US 2013/0113902 A1
(43) Pub. Date: May 9, 2013

(54) REMINDING METHOD FOR DAILY LIFE MANAGEMENT

(71) Applicant: MING-HSIEN HSU, Taipei (TW)

(72) Inventor: MING-HSIEN HSU, Taipei (TW)

(73) Assignee: INVENTEC CORPORATION, Taipei (TW)

(21) Appl. No.: 13/324,061

(22) Filed: Dec. 13, 2011

(30) Foreign Application Priority Data
Nov. 4, 2011 (TW) 100140376

(51) Int. Cl. H04N 7/18

(52) U.S. Cl. 348/61; 348/E07.085

(57) ABSTRACT

A reminding method of daily life management adapted for an electronic device configured with an imaging unit, a character recognizing unit, a database, and a processing unit, is disclosed, which comprises the steps of: using the imaging unit to capture an image of an object; enabling the character recognizing unit to perform a character recognition process upon the captured image and thus selecting a key word from the characters that are recognized in the character recognition process so as to be used as a file name for the captured image; enabling the processing unit to store the captured image using the file name into the database; and enabling the processing unit to carry out a reminding mode according to the file name stored in the database.

### FIELD OF THE INVENTION

The present invention relates to a reminding method for daily life management, and more particularly, to a method for assisting a user to track one's memo or note and thus reminding the user about what's the next thing to do in one's To-do list so as to manage the user's daily life efficiently without unnecessary waste both in time and money.

### BACKGROUND OF THE INVENTION

In the madness of modern life, it's easy to forget things that we had reminded ourselves again and again that it had to be done today, all because of our hectic lifestyles. Forgetting important things seems to be a day-to-day occurrence. For instance, we can forget to pay the parking fee or credit card payment in time and thus suffer the consequence of either being fined or damaging credit rating. Moreover, it may become a daily routine for many to forget buying certain items after returning from a shopping trip to one's local supermarket, or to spend a lot of time searching all of the house or office just for solving the question like “where on earth is my car key, my cellular phone, - - - ”.

For reminding ourselves of the things to do next, we are accustomed to keep memos or note in organizers, cellular phones, calendars, or on the back of a hand. However, it may be very time consuming to write or input characters for such memo/note keeping operations, resulting that after a period of time, a user may become lazy and fail to keep one's daily memo or note as organized as it should be. Not to mention that a memo printed on the back of a hand may look dirty and even sometimes cause stains to the clothing. In addition, although memos or notes recorded in one's cellular phone or calendar can be a good To-do list for reminding a user that there is a thing to do and it is about time to do exactly that, the user can still forget to do exactly the thing that he/she is being reminded when in a condition that the user is occupied and can not do the thing right away at the time of the reminding.

### SUMMARY OF THE INVENTION

In view of the disadvantages of prior art, the object of the present invention is to provide a method for assisting a user to track one's memo or note and thus reminding the user about what's the next thing to do in one's To-do list so as to manage the user's daily life efficiently without unnecessary waste both in time and money.

To achieve the above object, the present invention provides a reminding method of daily life management, comprising the steps of: providing an electronic device configured with an imaging unit, a character recognizing unit, a database, and a processing unit; using the imaging unit to capture an image of an object; enabling the character recognizing unit to perform a character recognition process upon the captured image and thus selecting a key word from the characters that are recognized in the character recognition process so as to be used as a file name for the captured image; enabling the processing unit to store the captured image using the file name into the database; and enabling the processing unit to carry out a reminding mode according to the file name stored in the database.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a flow chart depicting the steps performed in a reminding method of daily life management according to the present invention.

FIG. 2 is a schematic diagram showing an electronic device used in the present invention.

FIG. 3 is a flow chart depicting steps for confirming/modifying the file name of a captured image in the present invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

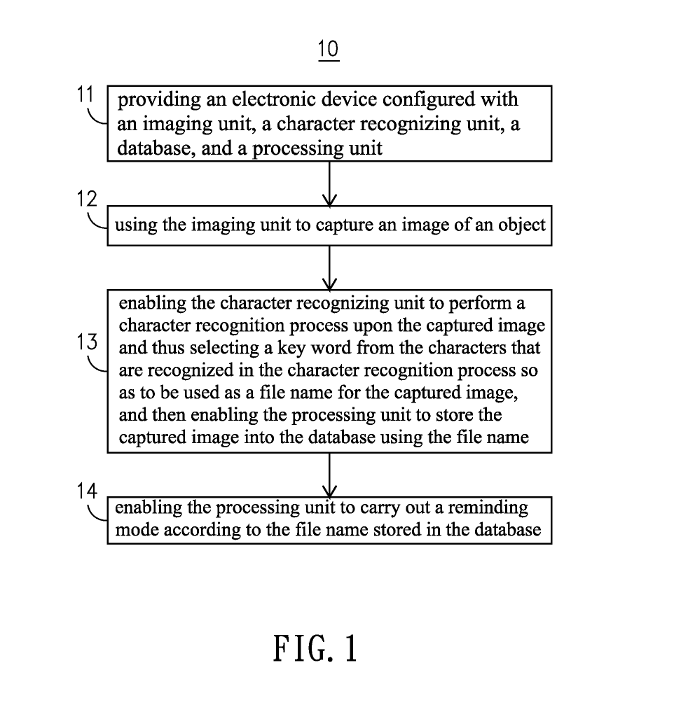

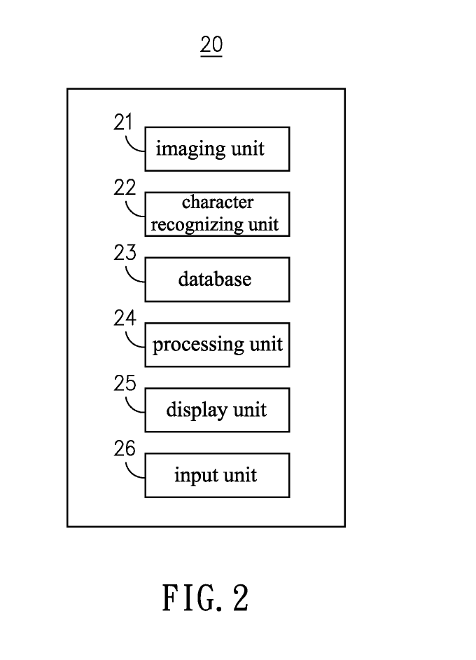

Please refer to FIG. 1, which is a flow chart depicting the steps performed in a reminding method of daily life management according to the present invention. As shown in FIG. 10, the flow chart 10 includes the following steps:
Step 11: an electronic device 20 is provided, which is configured with an imaging unit 21, a character recognizing unit 22, a database 23, a processing unit 24, a display unit 25 and an input unit, as shown in FIG. 2. In this embodiment of the invention, the electronic device 20 can be a small portable device, such as a cellular phone, a personal digital assistant (PDA), or a notebook computer, but is not limited thereby.
Step 12: the imaging unit 21 is used for capturing an image of an object, while enabling the captured image to be displayed on the display unit 25 of the electronic device 20.
Step 13: the character recognizing unit 22 is enabled to perform a character recognition process upon the captured image so as to select at least one key word from the characters that are recognized in the character recognition process to be used as a file name for the captured image; and thereafter, the processing unit 24 is enabled to store the captured image using the file name into the database 23 while allowing the file name associated to the captured image to be displayed on the display unit 25.
Step 14: the processing unit 24 is enabled to carry out a reminding mode according to the file name stored in the database 23.

Accordingly, the file name of the captured image, that is the file name registered in the database 23, should be accurately associated to the captured image so as to ensure the step 14 to be executed smoothly.

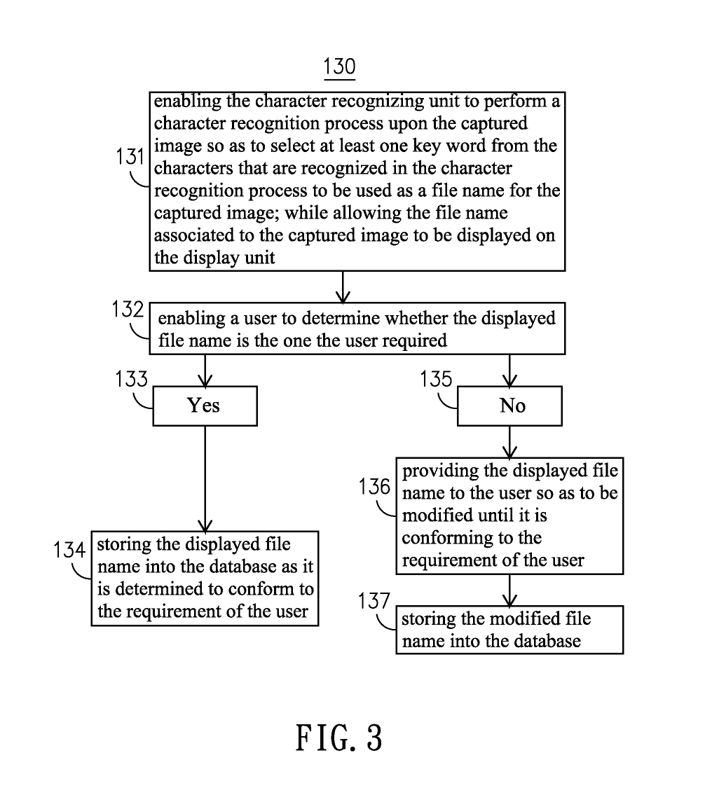

During the proceeding of the aforesaid steps, it is possible that an erroneous reminding mode could be enabled or even the proceeding of the aforesaid steps can not be executed smoothly for enabling any reminding mode, since the characters contained in the captured image may not be clear enough to be recognized correctly and thus three can be some erroneous recognitions in the character recognition process so that the resulting file name is erroneous and can not be used for enabling the reminding mode that it is supposed to do so. For preventing such unwanted condition from happening, before the file name that is recognized in the step 13 is to be stored into the database 23, a confirming/modifying procedure should be performed thereupon for ensuring the correctness of the file name. Thus, the step 13 of FIG. 1 is replaced by the step 130 that is shown in FIG. 3. The step 130 further comprising the following steps:
Step 131: the character recognizing unit 22 is enabled to perform a character recognition process upon the captured image so as to select at least one key word from the characters that are recognized in the character recognition process to be used as a file name for the captured image; while allowing the file name associated to the captured image to be displayed on the display unit 25.
Step 132: a user is enabled to determine whether the displayed file name is the one the user required; if so, the flow proceeds to step 133 so as to be directed to step 134; otherwise, the flow proceeds to step 135 so as to be directed to step 136.
Step 134: the displayed file name is stored into the database as it is determined to conform to the requirement of the user.
Step 136: the displayed file name is provided to the user for modification until it is conforming to the requirement of the user.
Step 137: the modified file name is stored into the database 23.

It is noted that the modification of the file name by the user can be performed through the use of the input unit 26. In this embodiment, the input unit 26 can be a device selected from the group consisting of: a keyboard, a pen tablet, and a voice input unit.

The following description relates to how the reminding method is performed according to an embodiment of the invention in view of the steps and devices provided in FIG. 1 to FIG. 3.

In a condition that as soon as an electricity bill is received by a user and the user is in control of an electronic device, as the step 11 shown in FIG. 1, the user will first control the imaging unit 21 to capture an image of the electricity bill, as the step 12 shown in FIG. 1, and then the captured image is provided to the character recognizing unit 22 so as to perform a character recognition process upon the captured image for allowing at least one key word to be selected from the characters that are recognized in the character recognition process and used as a file name for the captured image, while allowing the file name to be displayed on the display unit 25 of the electronic device 20, as the step 131 shown in FIG. 3. In this embodiment, since the electricity bill usually contains information including title, due date, payment amount, an so on, it is possible to have a file name, such as “electricitybill-100/12/25-1688”, to be generated for representing that the due date and the payment amount of the electricity bill are year 100, December 25 and NT$1,688. Then, the displayed file name is stored into the database 23 if it is determined to conform to the requirement of the user, as the step 133˜134 shown in FIG. 3. On the other hand, if it is not conformed to the requirement of the user, the displayed file name is provided to the user for modification until it is conforming to the requirement of the user, and then the modified file name is stored into the database 23, as the step 135˜137 shown in FIG. 3.

The aforesaid operation can be adapted for any papers such as receipts, vouchers, invoices, bills, credit card statements, etc., that attest to the payment of money, due date, and so on. However, as those information of due date, payment, etc., can be presented differently in different papers using different formats and different columns, the processing unit 24 can be adapted to recognize and process those different format into a unified format for displaying.

Nevertheless, if the object to be imaged in the present invention is not an electricity bill, but instead it is a bank book of user that is being carefully hidden under one's mattress. For relieving the user from the worrying that he/she might forget where the band book is after being hidden away for a long period of time, the user will first control the imaging unit 21 to capture an image of the ban book that is being hidden under the mattress, as the step 12 shown FIG. 1, and then the captured image is provided to the character recognizing unit 22 so as to perform a character recognition process upon the captured image for allowing at least one key word to be selected from the characters that are recognized in the character recognition process and used as a file name for the captured image, while allowing the file name to be displayed on the display unit 25 of the electronic device 20, as the step 131 shown in FIG. 3. In this embodiment, since the bank book usually contains information including bank name, title, account number, an so on, it is possible to have a file name, such as “bankname-deposit-12345”, to be generated for representing that the bank book with the account number of 12345. Then, the displayed file name is stored into the database 23 if it is determined to conform to the requirement of the user, as the step 133˜134 shown in FIG. 3. On the other hand, if it is not conformed to the requirement of the user, the displayed file name is provided to the user for modification until it is conforming to the requirement of the user, and then the modified file name is stored into the database 23, as the step 135˜137 shown in FIG. 3.

From the above description, it is noted that the file name should has at least one object name associated therewith, such as the electricity bill and the band book, and if the object to be imaged is a payment paper, the file name should further has a date associated therewith, such as the due date of the electricity bill. Operationally, in an operation that the processing unit 24 is enabled by a user to search the database 23 for finding if there is any file name stored in the database that is associated with the object name, and if the operation determines that there is a file name found to be associated with the object name, the processing unit 24 will be enabled to perform a corresponding reminding mode while enabling the image relating to the filename with the at least one object name to be displayed on the display unit 25, as the step 14 shown in FIG. 1. For instance, when a user is intended to obtain information relating to a specific electricity bill, the user can use the input unit 26 to input a complete file name associated with the specific electricity bill into the electronic device 20, the processing unit 24 will be enabled by a user to search the database 23 for finding the specific electricity bill with the inputted file name, and then enabled the result of the finding on the display unit 25. Moreover, the user can also simply input “electricity bill” into the electronic device 20 for enabling the processing unit 24 to search allover the database 23 for locating any information with file names that include “electricity bill”, and then enabled the result of all the electricity fills found on the display unit 25. Similarly, the user can also simply input “bank book” into the electronic device 20 for enabling the processing unit 24 to search allover the database 23 for locating any information with file names that include “bank book”, and then enabled the result of all the bank books found on the display unit 25.

For those payment bills with due dates, each of the corresponding file names that are generated in the present invention will have a date contained therein. Accordingly, the performing of the reminding mode according to the file name should be enabled to be carried out at a time before the due date. In this embodiment, the reminding mode may be performed as an audio signal for reminding the user to pay the bill before it is due, or a pop-up window on the display unit 25 for displaying the image of the bill along with the corresponding file name.

In addition, the reminding mode can further be performed using the correlation established between each object name and at least one position in a space defined according to a coordination system. Consequently, the processing unit 24 can be enabled to perform the reminding mode in a condition when the electronic device 20 is located within a specific range neighboring to the at least one position. Taking the aforesaid electricity bill for example, after the processing unit determines that the object name is associated to “electricity bill”, each and every location found in the coordinate system that can be associated to “electricity bill” will be marked for establishing correlations between the name of “electricity bill” with all those positions. In an embodiment, the coordinate system can be a satellite positioning system, such as the google map or a GPS, whichever is embedded inside the electronic device 20. Thereby, when the electronic device 20 that is carried by a user and is entering into a specific range neighboring to one of the aforesaid marked positions, the coordinate of the marked position will be detected by the processing unit 24 of the electronic device 20, so that the user can aware of the location where he/she can go and pay for the electricity bill. In this case, the positions being marked are locations of agencies for collecting electricity bill, which can be a financial institution, a post office, .a farmers' association, a fishermen's association, a savings and loan association, or even a convenient store. As soon as the electronic device 20 had detected one marked position, the processing unit 24 will be enabled to perform a corresponding reminding mode, which can includes an audio mode and a display mode. In an embodiment of the invention, the audio mode may be performed as an audio signal for reminding the user to pay the bill at the detected nearby location, or a pop-up window on the display unit 25 for displaying the image of the bill along with the corresponding file name for reminding the user to pay the bill at the detected nearby location. In a situation that there are more than one bills to be paid, the processing unit 24 is programmed to arrange the images of those bills into a list of image according to their respective due dates for enabling their corresponding reminding modes accordingly, and after the one bill on the top of the list is paid, the image relating to that bill will be deleted easily and the next in line can be moved up to the top. It is noted that there will be no reminding mode being enabled by the processing unit 24 if there is no corresponding image stored in database 23, i.e. the electronic device 20 will not issue any signal for reminding.

Similarly, the user is able to store a shopping list of products into the database. It is noted that the shopping list can contained products with expiration dates or products that are going to run out and required to be replenished, such as milk. In an embodiment, each and every product in the shopping list is imaged and stored in the database 23 while allowing the resulting file name to include the name of the product and its corresponding expiration date. Thereby, when the user run across a store which has one or more items in the shopping list, the electronic device will automatically issue an audio signal while enabling the items that can be brought in that store on the display unit for reminding the user to do the shopping accordingly. In addition, in a condition when one of the products in the list is about to expire, the processing unit 24 will also issue the audio and video signal to the user for reminding the user.

As for the amount of time that the electronic device 20 is set for reminding its user about a specific payment or a specific expiration date relating to a product that is stored in the database 23, it can be determined at will by the user. For instance, for any payment, the user can set the reminding signal to be issue once every day and three days or a week before the corresponding due date, or even exactly once at the due date, or in some case, once every other day or every three other days before the due date as well as exactly once at the due date.

Taking the aforesaid embodiment of bank book for example, in a condition when the user really forget where the bank book is, he/she can simply use the input unit 26 to into the characters of “bank book”, and then the processing unit 24 will be enabled to search the database 23 for locating any file name that is associated with the characters of “bank book” while allowing the images of the file names found to be displayed on the display unit 25. Similarly, instead of the characters of “bank book”, a complete file name relating to a specific band account can be inputted into the electronic device 20 through the input unit 26 for locating the bank book of the specific band account. Moreover, as the input unit 26 can be a voice input unit that is embedded in the electronic device 20, the user can simply talk to the electronic device 26 for inputting the file name or the characters of “bank book”. By the images displayed on the electronic device 20, the user can remember where exactly the bank book is, or even by the use of the positioning system embedded in the processing unit 24, the coordinate of the bank book can be identified and provided to the user for finding the same. In addition, in order to prevent the electronic device 20 to be accessed by other persons other than its lawful user and thus to be used for obtaining the location of the bank book, a personal code can be encoded into the electronic device 20 by the user. For discriminating from the file names of those bills with due date and those with expiration date, the file names of collectable items, such as the aforesaid bank book, are generated without being associated to any date. Consequently, when the processing unit 24 is enabled to access a file name that is not associated to a date, the processing unit 24 will not be prepared to perform a reminding mode, but instead, it will be prepared to search the database 23 according to the command from the user. Therefore, the principle for generating file names for those collectable items is that: the file name should be directly correlated with the name of the collectable item, such as bank book, key, jewelry, and so on. Nevertheless, if it is intended for enabling the electronic device 20 to remind the user the whereabouts of a specific collectable item either periodically or irregularly, the file name of the specific item can also be attached with a date.

To sum up, the present invention can provide a method for assisting a user to track one's memo or note and thus reminding the user about what's the next thing to do in one's To-do list so as to manage the user's daily life efficiently without unnecessary waste both in time and money. Nevertheless, the performing of the aforesaid reminding method in view of searching the database 23 for locating images conforming to a given date or character can be accelerated either by dividing the database 23 into a plurality of sub-databases for storing images of different categories in respectively, or by arranging a plurality of databases in the electronic device 20. However, before there can be any images available in the database, the imaging step should be performed first and also the format of the file name for each of the captured images should be standardized. With sufficient images stored in the database that are also associated with standardized file names, the reminding method is capable of assisting a user for reminding the user with a reminding mode that is enabled according to the file name stored in the database.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A reminding method of daily life management, comprising the steps of:
providing an electronic device configured with an imaging unit, a character recognizing unit, a database, and a processing unit;
using the imaging unit to capture an image of an object;
enabling the character recognizing unit to perform a character recognition process upon the captured image and thus selecting a key word from the characters that are recognized in the character recognition process so as to be used as a file name for the captured image;
enabling the processing unit to store the captured image using the file name into the database; and
enabling the processing unit to carry out a reminding mode according to the file name stored in the database.

2. The reminding method of claim 1, wherein the file name has at least one object name associated therewith, and thereby, in an operation that the processing unit is enabled by a user to search the database for finding if there is any file name stored in the database that is associated with the at least one object name, and if the operation determines that there is a file name found to be associated with the at least one object name, the processing unit is enabled to perform the reminding mode that is corresponding thereto while enabling the image relating to the filename with the at least one object name to be displayed.

3. The reminding method of claim 2, wherein the file name has a date associated therewith, and thereby, the performing of the reminding mode according to the file name is enabled to be carried out at a time before the date.

4. The reminding method of claim 3, further comprising the step of:
establishing the correlation between each object name and at least one position in a space defined according to a coordination system, and consequently, enabling the processing unit to perform the reminding mode in a condition when the electronic device is located within a specific range neighboring to the at least one position.

5. The reminding method of claim 4, wherein the remind mode includes an audio mode and a display mode for enabling the image to be displayed.

6. The reminding method of claim 4, wherein the coordinate system is a satellite positioning system.

7. The reminding method of claim 1, wherein the electronic device further includes an input unit, to be used by a user for inputting a file name into the electronic device, and thus enabling the processing unit to search the database for finding if there is any file name stored in the database that is associated with the inputted file name, and if so, enabling the electronic device to display the image corresponding to the inputted file name.

8. The reminding method of claim 7, wherein the electronic device further includes a display unit, to be used for displaying the image corresponding to the inputted file name.

9. The reminding method of claim 7, wherein the input unit is a device selected from the group consisting of: a keyboard, a pen tablet, and a voice input unit.

10. The reminding method of claim 1, wherein the electronic device further includes a display unit, to be used for displaying the file name identified by the recognizing unit from the performing of the character recognition process upon the captured image so as to be used for allowing a user to determine whether the file name of the captured image is the one the user required; and if so, the captured image is stored into the database using the file name; otherwise, the file name is modified so as to enable the captured image to be stored into the database using the modified file name.
